(19) United States
(12) Patent Application Publication
(10) Pub. No.: US 2013/0007521 A1
(43) Pub. Date: Jan. 3, 2013

(54) SYNCHRONOUS TEST CONTROL SYSTEM AND METHOD USING TESTING DEVICE

(75) Inventors: TAN-KE LUO, Shenzhen City (CN); JUN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/244,607

(22) Filed: Sep. 25, 2011

(30) Foreign Application Priority Data
Jun. 28, 2011 (CN) 201110177413.3

(51) Int. Cl. G06F 11/28

(52) U.S. Cl. 714/32; 714/E11.178

(57) ABSTRACT

A system and method for controlling a synchronous test in a testing device include inserting a synchronous command into a test program of the testing device, and defines a first synchronous data and a second synchronous data for the testing device. When the synchronous command is executed by the test program, the method sends a pause command to suspend the test program and to send the first synchronous data into the shared file of a host device. The testing device monitors whether the second synchronous data exists in the shared file, when sending the first synchronous data to the host device. If the second synchronous data is monitored in the shared file, the method informs a processor of the testing device to execute the test program continually.

### BACKGROUND

1. Technical Field

Embodiments of the present disclosure relate to test control systems and methods, and more particularly to a synchronous test control system and method using a testing device.

2. Description of Related Art

A server storage system may include two (or more than two) servers. In order to test the two servers, a synchronous interaction test of the two servers may be performed. In such a test, test programs in the two servers may be sometimes executed asynchronously because of varied operation factors. When the programs are required to be tested interactively, the test may result in failure if the test programs are executed asynchronously. Therefore, waste of testing time and material resources may be generated, and the process may be inefficient.

### BRIEF DESCRIPTION OF THE DRAWINGS

FIG. 1 is a schematic diagram of one embodiment of a testing device including a control system.

FIG. 2 is a block diagram of one embodiment of the control system of FIG. 1.

FIG. 3 is a flowchart of one embodiment of a method for controlling a synchronous test using the testing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

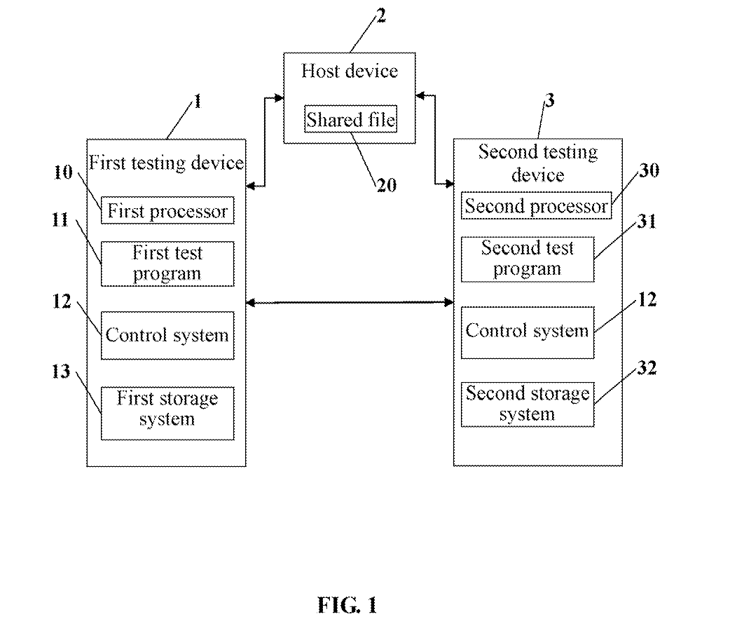

FIG. 1 is a schematic diagram of one embodiment of a synchronous test control system (hereinafter “the control system 12”) implemented by a first testing device 1 and a second testing device 3. In the embodiment, the first testing device 1 and the second testing device 3 both communicate with a host device 2. The first testing device 1 and the second testing device 3 are, in one example, two servers in a storage server system (not shown in the FIG. 1) that can be used to perform a synchronous test together. In one embodiment, the storage server system includes a plurality severs to store data. The host device 2 may be a server. The host device 2 includes a shared file 20 that is shared with the first testing device 1 and the second testing device 3. The control system 12 may control the first testing device 1 and the second testing device 3 to perform the synchronous test synchronously.

The first testing device 1 further includes a first processor 10, a first test program 11, and a first storage system 13. The first test program 11 may include a plurality of lines of codes or instructions. The first processor 10 may execute the first test program 11 and the control system 12 in the form of one or more computerized codes, to provide the synchronous test functionality of the first testing device 1. The first storage system 13 may be a memory of the first testing device 1, or external storage cards, such as smart media (SM) cards, or secure digital (SD) cards.

The second testing device 3 further includes a second processor 30, a second test program 31, and a second storage system 32. The second test program 31 also may include a plurality of lines of codes or instructions. The second processor 30 may execute the second test program 31 and the control system 12, which are in the form of one or more computerized codes, to provide the synchronous test functionality of the second testing device 3. The second processor 30 may execute the second test program 31. The second storage system 32 may be a memory of the second testing device 3, or external storage cards, such as smart media (SM) cards, or secure digital (SD) cards.

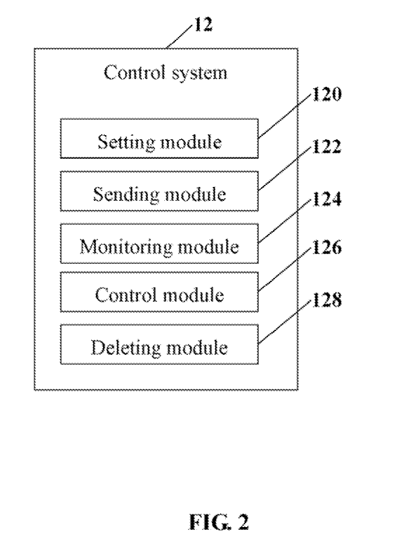

FIG. 2 is a block diagram of one embodiment of the control system of FIG. 1. In the embodiment, the control system 12 may include a setting module 120, a sending module 122, a second module 124, a control module 126, and a deleting module 128. The modules 120, 122, 124, 126 and 128 comprise computerized codes in the form of one or more programs that are stored in the first storage system 13 or the second storage system 32. The computerized code includes instructions that are executed by the first processor 10 or the second processor 30 to provide functions for the modules. Details of these operations are as follows.

The setting module 120 inserts a synchronous command into the first test program 11, and insert the synchronous command into the second test program 31. In the embodiment, the synchronous command may be a line of instructions or code for informing the first processor 10 or the second processor 30 that the first test program 11 and a second test program 31 are required to be tested synchronously and interactively. As such, the first test program 11 controls the first testing device 1 to interact with the second testing device 3 using the synchronous command, or the second test program 31 controls the second testing device 3 to interact with the first testing device 1 using the synchronous command. For example, if the second testing device 3 responds to a request when the request is sent from the first testing device 1, the second testing device 3 interacts with the first testing device 1.

The setting module 120 further defines a first synchronous data and a second synchronous data for the first testing device 1, and defines the first synchronous data and the second synchronous data for the second testing device 3. In one embodiment, the second synchronous data is data that monitors an interactive device of the first testing device 1 or the second testing device 3 (“the monitoring data”). The interactive device is a device that performs the synchronous test with the first testing device 1 or the second testing device 3. For example, the interactive device of the first testing device 1 is the second testing device 3. Therefore, the first synchronous data of the second testing device 3 is defined as the second synchronous data for the first testing device 1, and the first synchronous data of the first testing device 1 is defined as the second synchronous data for the second testing device 3. The first synchronous data may be a ready signal of the first testing device 1 or the second testing device 3.

The first processor 10 executes the first test program 11 in the first testing device 1, and the second processor 30 executes the second test program 31 in the second testing device 3. When the synchronous command is executed by the first test program 11 or the second test program 31, the sending module 122 sends a pause command to the first processor 10 for suspending the first test program 11, or sends the pause command to the second processor 30 for suspending the second test program 31. In one embodiment, the pause command is a command to make the first processor 10 or the second processor 30 stop executing the first test program 11 and the second test program 31. The sending module 122 further sends the first synchronous data of the first testing device 1 or the second testing device 3 into the shared file 20. For example, if the synchronous command is executed by the first test program 11, the sending module 122 sends the pause command to suspend the first test program 11, and sends the first synchronous data of the first testing device 1 into the shared file 20. If the synchronous command is executed by the second test program 31, the sending module 122 sends the pause command to suspend the second test program 31, and sends the first synchronous data of the second testing device 3 into the shared file 20.

The second module 124 monitors whether the shared file 20 includes the second synchronous data for the first testing device 1 or for the second testing device 3, after sending the first synchronous data of the first testing device 1 or the second testing device 3 into the shared file 20. When the first synchronous data of the first testing device 1 are sent to the shared file 20, the second module 124 monitors whether the shared file 20 includes the first synchronous data of the second testing device 3. When the first synchronous data of the second testing device 3 are sent to the shared file 20, the second module 124 monitors whether the shared file 20 includes the first synchronous data of the first testing device 1.

When the shared file includes the second synchronous data 20, the control module 126 executes the first test program 11 or the second test program 31 continually to perform the synchronous test. When the first synchronous data of the second testing device 3 are monitored in the shared file 20, the control module 126 informs the first processor 10 to execute the first test program 11. When the first synchronous data of the first testing device 1 are monitored in the shared file 20, the control module 126 informs the second processor 30 to execute the second test program 31.

The deleting module 128 informs the host device 2 to delete the first synchronous data and the second synchronous data from the shared file 20.

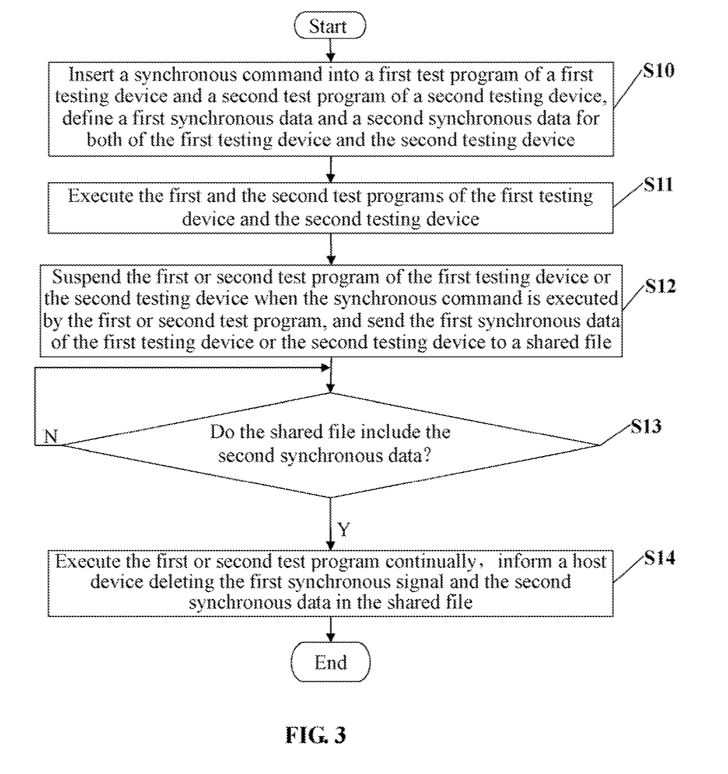

FIG. 3 is a flowchart of one embodiment of a method for controlling a synchronous test using the control system 12 included in the first testing device 1 and the second testing device 3. Depending on the embodiment, additional blocks may be added, others deleted, and the ordering of the blocks may be changed.

In block S10, the setting module 120 inserts a synchronous command into the first test program 11, inserts the synchronous command into the second test program 31, and defines a first synchronous data and a second synchronous data for the first testing device 1, and a first synchronous data and a second synchronous data for the second testing device 3. In one embodiment, the second synchronous data is data that monitors an interactive device of the first testing device 1 or the second testing device 3 (“the monitoring data”). The interactive device is a device that performs the synchronous test with the first testing device 1 or the second testing device 3. The first synchronous data may be a ready signal of the first testing device 1 or the second testing device 3.

In block S11, the first processor 10 executes the first test program 11 in the first testing device 1, and the second processor 30 executes the second test program 31 in the second testing device 3.

When the synchronous command is executed by the first test program 11 or the second test program 31, in block S12, the sending module 122 sends a pause command to suspend the first test program 11 or the second test program 31, and sends the first synchronous data of the first testing device 1 or the second testing device 3 into the shared file 20 of the host device 2.

In block S13, the second module 124 monitors whether the shared file 20 includes the second synchronous data after the sending of the first synchronous data. If the second synchronous data is monitored in the shared file 20, block S14 is implemented. Otherwise, if the second synchronous data is not monitored in the shared file 20, block S13 is repeated.

In block S14, the control module 126 informs the first processor 10 or the second processor 30 to execute the first test program 11 or the second test program 31 continually to perform the synchronous test, and the deleting module 128 informs the host device 2 to delete the first synchronous data and the second synchronous data from the shared file 20.

It should be emphasized that the described exemplary embodiments are merely possible examples of implementations, and have been set forth for a clear understanding of the principles of the present disclosure. Many variations and modifications may be made to the described exemplary embodiments without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for controlling a synchronous test in a first testing device, the first testing device in communication with a host device, the method comprising:
inserting a synchronous command into a first test program of the first testing device;
defining a first synchronous data and a second synchronous data for the first testing device;
sending a pause command to suspend the first test program and sending the first synchronous data into a shared file of the host device, upon the condition that a first processor of the first testing device executes the first test program and the synchronous command is executed by the first test program;
monitoring whether the shared file includes the second synchronous data in response to the first synchronous data being sent to host device;
informing the processor to execute the first test program continually to perform the synchronous test, upon the condition that the second synchronous data is monitored in the shared file.

2. The method as claimed in claim 1, further comprising:
informing the host device to delete the first synchronous data and the second synchronous data from the shared file in response to the second synchronous data is monitored in the shared file.

3. The method as claimed in claim 2, wherein the first synchronous data is a ready signal of the first testing device, and the second synchronous data is a ready signal of a second testing device that performs the synchronous test with the first testing device.

4. The method as claimed in claim 3, wherein the synchronous command is a line of instructions or code for informing the processor that the first test program of the first testing device and a second test program of the second testing device are required to be tested interactively.

5. The method as claimed in claim 1, wherein the shared file is stored in the host device, and is shared with the first testing device and the second testing device.

6. A non-transitory storage medium storing a set of instructions, the set of instructions capable of being executed by a processor to perform a method for controlling a synchronous test in a first testing device, the first testing device in communication with a host device, the method comprising:
inserting a synchronous command into a first test program of the first testing device;
defining a first synchronous data and a second synchronous data for the first testing device;
sending a pause command to suspend the first test program and sending the first synchronous data into a shared file of the host device, upon the condition that a processor of the first testing device executes the first test program and the synchronous command is executed by the first test program;
monitoring whether the shared file includes the second synchronous data, in response to sending the first synchronous data to host device;
informing the processor to execute the first test program continually to perform the synchronous test, upon the condition that the second synchronous data is monitored in the shared file.

7. The storage medium as claimed in claim 6, further comprising:
informing the host device to delete the first synchronous data and the second synchronous data in the shared file, in response to the second synchronous data is monitored in the shared file.

8. The storage medium as claimed in claim 6, wherein the first synchronous data is a ready signal of the first testing device, and the second synchronous data is a ready signal of a second testing device which performs the synchronous test with the first testing device.

9. The storage medium as claimed in claim 8, wherein the synchronous command is a line of instructions or code for informing the first processor that the first test program of the first testing device and a second test program of the second testing device are required to be tested interactively.

10. The storage medium as claimed in claim 6, wherein the shared file is stored in the host device, and is shared with the first testing device and the second testing device.

11. A first testing device, the first testing device comprising:
a storage system, a processor; and
one or more programs that are stored in a storage system and are executed by the processor, the one or more programs comprising:
a setting module operable to insert a synchronous command into a first test program of the first testing device, and define a first synchronous data and a second synchronous data for the first testing device;
a sending module operable to send a pause command to suspend the first test program and sending the first synchronous data into a shared file of a host device, upon the condition that a processor of the first testing device executes the first test program and the synchronous command is executed by the first test program;
a second module operable to monitor whether the shared file includes the second synchronous data, in response to sending the first synchronous data to host device;
a control module operable to notify the processor to execute the first test program continually, upon the condition that the second synchronous data is monitored in the shared file.

12. The first testing device as claimed in claim 11, the one or more programs further comprise:
a deleting module operable to notify the host device deleting the first synchronous data and the second synchronous data in the shared file, in response to the second synchronous data is monitored in the shared file.

13. The first testing device as claimed in claim 11, wherein the first synchronous data is a ready signal of the first testing device, and the second synchronous data is a ready signal of a second testing device that performs the synchronous test with the first testing device.

14. The first testing device as claimed in claim 13, wherein the synchronous command is a line of instructions or code for informing the first processor that the first test program of the first testing device and a second test program of the second testing device are required to be tested interactively.

15. The first testing device as claimed in claim 11, wherein the shared file is stored in the host device, and is shared with the first testing device and the second testing device.
